(19) United States
(12) Patent Application Publication
(10) Pub. No.: US 2022/0041794 A1
(43) Pub. Date: Feb. 10, 2022

(54) Hydroxyl-Functional Inherent Matting Waterborne Polyurethanes and High Performance Inherent Matting Coating Composed by the Same

(71) Applicant: Shanghai Sisheng Polymer Materials Co., Ltd., Shanghai (CN)

(72) Inventors: Ziao Wei, Shanghai (CN); Yuchun Wei, Shanghai (CN)

(21) Appl. No.: 17/126,308

(22) Filed: Dec. 18, 2020

(30) Foreign Application Priority Data
Aug. 10, 2020 (CN) 202010793228.6

(51) Int. Cl. C08G 18/75; C08G 18/44; C08G 18/42; C08G 18/32; C08G 18/22; C09D 175/04; C08L 75/04

(52) U.S. Cl. CPC C08G 18/755; C08G 18/758; C08G 18/44; C08G 18/4263; C08L 75/04; C08G 18/3206; C08G 18/227; C09D 175/04; C08G 18/3228

(57) ABSTRACT

The disclosure relates to a method for preparing a hydroxyl-functional inherent matting waterborne polyurethane and a high-performance inherent matting coating made of the same. The inherent matting waterborne polyurethane includes the following components in parts by weight: a polymer polyol 15-25 parts; an isocyanate monomer 5-15 parts; 2,2-dimethylol propionic acid or 2,2-dimethylol butyric acid 0.2-0.8 parts; a pH regulator 0.1-0.7 parts; a hydroxyalkyl ethylenediamine chain extender 0.5-3.0 parts; a dialkyl alcohol amine blocking agent 0.1-4.0 parts; a diaminosulphonate chain extender 0.2-1.5 parts; a catalyst 0.01-0.05 parts; an organic solvent 2-10 parts; deionized water 50-80 parts; a thickener 0.1-3 parts. In the post-chain extension stage of the waterborne polyurethane, through hydroxyalkyl ethylene diamine chain extension and dialkyl alcohol amine blocking, hydroxyl groups are introduced into the polymer molecular chain.

### CROSS-REFERENCE TO RELATED APPLICATIONS

This application claims the priority of Chinese Patent Application No. 202010793228.6, entitled “Hydroxyl-functional inherent matting waterborne polyurethane and high-performance inherent matting coating composed by the same” filed with the China National Intellectual Property Administration on Aug. 10, 2020, which is incorporated herein by reference in its entirety.

### FIELD OF THE INVENTION

The disclosure relates to the field of polymer materials, in particular to a method for preparing a hydroxyl-functional waterborne polyurethane with inherent matting performance, and to a method for preparing a high-performance inherent matting coating by using the above polyurethane in conjunction with a crosslinker.

### BACKGROUND

The environmental friendly character of waterborne polyurethane is well known. In recent years, related matting coatings have developed rapidly, and the optical properties of their paintcoats have become more and more important. Usually matting paintcoats can be obtained by adding matting agents, for example inorganic or organic matting agents, such as silica, polyurethane and polyacrylate particles. However, paintcoats with matting agents usually have disadvantages of poor resistance to friction, poor transparency, poor matting effect, etc. In addition, the matting agent in the application of waterborne coating system has disadvantages such as easy to thicken, settling and agglomeration, degradation of the physical properties of the coating film, and uneven optical effects on the surface of the material.

At present, many inherent matting waterborne polyurethanes that have been researched and reported are usually one-pack, without hydroxyl groups and other cross-linked groups. Patents CN102112510B and CN103865031B use aqueous anionic polyurethane dispersions to stabilize polymer emulsion and maintain redispersibility of polymer particles by 2,2-dimethylol propionic acid which contains hydrophilic groups and diaminosulphonate which reserved as post-chain extenders. Patents CN110204682B and WO2012020026A1 disclose a method for preparing an aqueous nonionic polyurethane dispersion, which has a larger particle size and a wider particle size distribution, and is easy to redisperse, and its polymer coating film has a lower gloss. Patents CN106519133A and WO2016102596A1 discloses that polyurethane-vinyl polymer hybrid particles are obtained by free-radical polymerization of at least one vinyl monomer in the presence of polyurethane. It is said that the transparency of the polymer coating film can be significantly improved when preparing the inherent matting coatings.

Even if the above inherent matting waterborne resin is added with water-dispersed polyisocyanate crosslinkers and aziridine crosslinkers, the improvement of its performance is very limited due to the few effective cross-linking points. In order to overcome the above problems, the present disclosure designs an inherent matting waterborne polyurethane with a high hydroxyl content. By adding water-dispersed polyisocyanates or amino resin crosslinkers into the inherent matting waterborne polyurethane to make hydroxyl groups crosslink to form a macromolecular network structure with high density, an inherent matting waterborne polyurethane paintcoat can be obtained.

### SUMMARY OF THE INVENTION

The technical problem to be solved by the present disclosure is to provide a method for preparing a hydroxyl-functional inherent matting waterborne polyurethane. The coating film formed by the same exhibits low gloss, and the polymer contains many hydroxyl groups on the molecular chain. When a crosslinker is added, it can provide more cross-linking points and the film formed after curing has excellent physical and chemical properties.

Another technical problem to be solved by the present disclosure is to provide a use of the above-mentioned waterborne polyurethane and a method for preparing the coating with the same. By using the above-mentioned waterborne polyurethane in conjunction with a crosslinker, a two-pack or one-pack inherent matting waterborne coating with high-performance can be prepared.

As used herein, the singular forms “a”, “an” and “the” are intended to include the plural forms as well, unless the context clearly indicates otherwise.

The disclosure is realized through the following technical scheme: A hydroxyl-functional inherent matting waterborne polyurethane, comprising the following components:

15-25 parts by weight of a polymer polyol;
5-15 parts by weight of an isocyanate monomer;
0.2-0.8 parts by weight of 2,2-dimethylol propionic acid or 2,2-dimethylol butyric acid;
0.1-0.7 parts by weight of a pH regulator;
0.5-3.0 parts by weight of a hydroxyalkyl ethylenediamine chain extender;
0.1-4.0 parts by weight of a dialkyl alcohol amine blocking agent;
0.2-1.5 parts by weight of a diaminosulphonate chain extender;
0.01-0.05 parts by weight of a catalyst;
2-10 parts by weight of an organic solvent;
50-80 parts by weight of deionized water;
0.1-3 parts by weight of a thickener;
wherein, the polyurethane has a hydroxyl content of 0.5-2.5% based on dry solids,
which is calculated as follow:

$$OH \% = \frac{{M}_{OH} \times 17}{W \times w \%} \times 100 \%$$

wherein
OH % refers to the hydroxyl content as described above;
M_{OH} refers to the mole number of hydroxyl groups added by the chain extension reaction and blocking reaction;
W refers to the weight of the polyurethane emulsion, in grams;
w % refers to the solid content of the polyurethane emulsion.

Based on the above technical solution, the polymer polyol is one of conventional polyester polyol, polytetrahydrofuran ether polyol (PTMG), ethylene oxide polyether polyol (PEG), propylene oxide polyether polyol (PPG), polycaprolactone polyol (PCL), polycarbonate polyol (PCD) and polyacrylate polyol (PA), or a mixture of several kinds thereof. The molecular weight thereof ranges from 500 to 3000, for example 1000 to 2000, and functionality thereof ranges from 2 to 3.

Based on the above technical solution, the isocyanate monomer is one of isophorone diisocyanate (IPDI), dicyclohexylmethane diisocyanate (HMDI), tetramethylxylylene diisocyanate (TMXDI), xylylene diisocyanate (XDI), 2,4- and/or 2,6-toluene diisocyanate (TDI), or a mixture of several kinds thereof. In some embodiments, the isocyanate monomer is isophorone diisocyanate (IPDI) and/or dicyclohexylmethane diisocyanate (HMDI).

Based on the above technical solution, the hydrophilic monomer is 2,2-dimethylol propionic acid or 2,2-dimethylol butyric acid. In some embodiments, the hydrophilic monomer is 2,2-dimethylol propionic acid.

Based on the above technical solution, the pH regulator is triethylamine or N-methylmorpholine. In some embodiments, the pH regulator is triethylamine.

Based on the above technical solution, after the prepolymer reactants are dispersed in water, the —NH₂ or —NH at both ends of the hydroxyalkyl ethylenediamine chain extender is subjected to a chain extension reaction with —NCO at both ends of the prepolymer, at the same time, the hydroxyl —OH is introduced into the polymer chain. The reaction process is as follows:

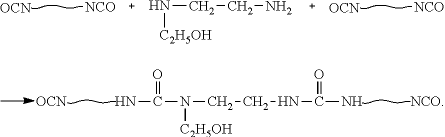

The above hydroxyalkyl ethylenediamine chain extender is one of hydroxyethyl ethylenediamine, hydroxypropyl ethylenediamine, N,N-dihydroxyethyl ethylenediamine, and (1,2-ethanediyldiimino)bis-1-butanol, or a mixture of several kinds thereof; in some embodiments, it is hydroxyethyl ethylenediamine.

Based on the above technical solution, the dialkyl alcohol amine blocking agent is one of diethanolamine, diisopropanolamine and dibutanolamine, or a mixture of several kinds thereof; in some embodiments, it is diethanolamine. After the initial prepolymer reactants are dispersed in water, a hydroxyalkyl ethylenediamine chain extender can be used to introduce hydroxyl-OH into the polymer macromolecular chain, and a secondary amine containing two hydroxyl groups can be used to block the polymer to increase the content of hydroxyl group in the polymer macromolecular chain. The reaction process is as follows:

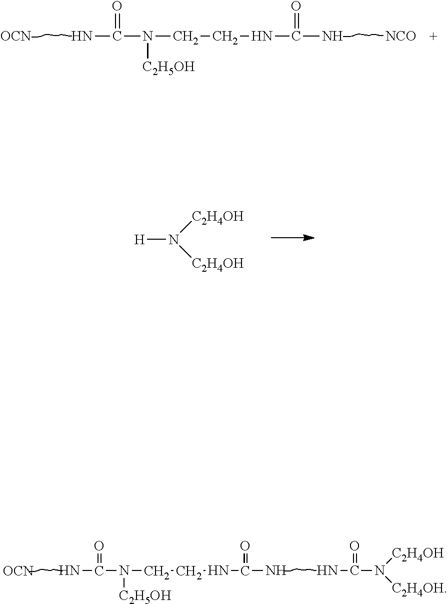

Based on the above technical solution, the diaminosulphonate chain extender is one of sodium 2-[(2-aminoethyl)amino]ethanesulfonate and/or sodium 3-[(2-aminoethyl)amino]propanesulfonate. In some embodiments, the diaminosulphonate chain extender is sodium 2-[(2-aminoethyl)amino]ethanesulfonate.

Based on the above technical solution, the catalyst is organic tin, organic bismuth or organic silver. In some embodiments, the catalyst is organic bismuth.

Based on the above technical solution, the organic solvent is one of N-methylpyrrolidone, N-ethylpyrrolidone, dimethylacetamide, dimethylformamide, acetone and ketone, or a mixture of several kinds thereof. In some embodiments, the organic solvent is acetone.

Based on the above technical solution, the thickener is one of alkali-swelling polyacrylic acid and associative hydrophobically modified polyurethane, or a mixture of several kinds thereof. In some embodiments, the thickener is alkali-swelling polyacrylic acid.

The above-mentioned method for preparing the waterborne polyurethane includes the following steps: (a) adding the polymer polyol, isocyanate monomer, 2,2-dimethylol propionic acid or 2,2-dimethylol butyric acid, catalyst and organic solvent to a reactor according to the formula amount and reacting at 50-90° C. until the NCO content reaches or becomes less than the theoretical value, in which the isocyanate monomer is excessive; (b) cooling the above polymer to 20-40° C., adding the formula amount of pH regulator such as triethylamine or N-methylmorpholine, and then dispersing the above reactants into the formula amount of deionized water at a high speed; (c) adding the formula amount of the hydroxyalkyl ethylenediamine chain extender, and reacting at 10-50° C. for 5-8 min; (d) adding the formula amount of the diaminosulphonate chain extender, and reacting at 10-50° C. for 5-8 min; (e) adding the formula amount of the dialkyl alcohol amine blocking agent, and reacting at 10-50° C. for another 30-60 min to obtain a waterborne polyurethane; (f) thickening the waterborne polyurethane with a thickener, with the proviso that before the thickening, if the organic solvent added in step (a) has a high boiling point such as N-methyl-pyrrolidone, the solvent does not require to be separated; if the solvent added in step (a) is acetone or butanone, the solvent needs to be separated under reduced pressure.

The use of the above-mentioned waterborne polyurethane for preparing a two-pack or one-pack inherent matting waterborne coating with high-performance is provided. A two-pack coating that is prepared by adding 5-20% by weight of a water-dispersed polyisocyanate crosslinker into the hydroxyl-functional inherent matting waterborne polyurethane may be cured at room temperature. A one-pack coating that is prepared by adding 5-18% by weight of an amino resin crosslinker into the hydroxyl-functional inherent matting waterborne polyurethane may be cured after being baked at 120-140° C. for 20 min. Paintcoats prepared by above coatings exhibit low gloss, excellent water resistance and solvent resistance, and have a gloss of less than 1.0 at 60 degrees. They can be widely used in various substrates such as leather, fabric, wood, metal, cement, and plastic.

The present disclosure has the following beneficial effects: in the present disclosure, a hydroxyl-functional waterborne polyurethane with inherent matting properties is obtained; by adding a water-dispersed polyisocyanate or an amino resin crosslinker into the waterborne polyurethane obtained, a two-pack or one-pack inherent matting waterborne coating with excellent physical and chemical properties can be prepared.

### DESCRIPTION

### Example 1

The preparation method was provided as follows: 12.1 parts by weight of polycarbonate (molecular weight: 2000), 12.1 parts by weight of polytetrahydrofuran ether diol (molecular weight: 2000), 0.45 parts by weight of 2,2-dimethylol propionic acid, and 7.6 parts by weight of isophorone diisocyanate, 4.4 parts by weight of acetone, and 0.01 parts by weight of organic bismuth catalyst were added to a reactor and reacted at 60-70° C. for 3 hours; the resulting polymer was cooled to 20-40° C.; 0.33 parts by weight of pH regulator triethylamine was added and stirred evenly; the resulting mixture was dispersed into 64.8 parts by weight of deionized water at a high speed; 1.4 parts by weight of hydroxyethyl ethylenediamine was added and reacted for 5-8 min without heating, and then 0.77 parts by weight of sodium 2-[(2-aminoethyl)amino]ethanesulfonate with 50% content was added and reacted for 5-8 min without heating; finally, 0.43 parts by weight of diethanolamine was added and reacted for 30 min without heating to obtain a waterborne polyurethane. Under heating and negative pressure conditions, acetone was removed. The waterborne polyurethane was thickened with alkali-swelling polyacrylic acid thickener to a viscosity of 1000-2000 mPa·s.

The resulting waterborne polyurethane product has a solid content of 34.8% and a hydroxyl content of 1.06% (calculated by dry solids).

### Example 2

The preparation method was provided as follows: 9.9 parts by weight of polycarbonate (molecular weight: 1000), 9.9 parts by weight of polyphthalic anhydride-neopentyl glycol diol (molecular weight: 1000), 0.53 parts by weight of 2,2-dimethylol propylene acid, 11.1 parts by weight of isophorone diisocyanate, 5.5 parts by weight of acetone, and 0.01 parts by weight of organic bismuth catalyst were added to a reactor and reacted at 60-70° C. for 3 hours; the resulting polymer was cooled to 20-40° C.; 0.4 parts by weight of pH regulator triethylamine was added and stirred evenly; the resulting mixture was dispersed into 64.5 parts by weight of deionized water at a high speed; 1.94 parts by weight of hydroxyethyl ethylenediamine was added and reacted for 5-8 min without heating, and then 1.07 parts by weight of sodium 2-[(2-aminoethyl)amino]ethanesulfonate with 50% content was added and reacted for 5-8 min without heating; finally, 0.69 parts by weight of diethanolamine was added and reacted for 30 min without heating to obtain a waterborne polyurethane. Under heating and negative pressure conditions, acetone was removed. The waterborne polyurethane was thickened with alkali-swelling polyacrylic acid thickener to a viscosity of 1000-2000 mPa·s.

The resulting waterborne polyurethane product has a solid content of 35% and a hydroxyl content of 1.54% (calculated by dry solids).

### Example 3

The preparation method was provided as follows: 9.5 parts by weight of polycarbonate (molecular weight: 1000), 9.5 parts by weight of polyphthalic anhydride-neopentyl glycol diol (molecular weight: 1000), 0.5 parts by weight of 2,2-dimethylol propylene acid, 5.0 parts by weight of dicyclohexylmethane diisocyanate, 6.5 parts by weight of isophorone diisocyanate, 8.8 parts by weight of acetone, and 0.01 parts by weight of organic bismuth catalyst were added to a reactor and reacted at 60-70° C. for 3 hours; the resulting polymer was cooled to 20-40° C.; 0.38 parts by weight of pH regulator triethylamine was added and stirred evenly; the resulting mixture was dispersed into 64.5 parts by weight of deionized water at a high speed; 1.27 parts by weight of hydroxyethyl ethylenediamine was added and reacted for 5-8 min without heating, and then 1.03 parts by weight of sodium 2-[(2-aminoethyl)amino]ethanesulfonate with 50% content was added and reacted for 5-8 min without heating; finally, 1.86 parts by weight of diethanolamine was added and reacted for 30 min without heating to obtain a waterborne polyurethane. Under heating and negative pressure conditions, acetone was removed. The waterborne polyurethane was thickened with alkali-swelling polyacrylic acid thickener to a viscosity of 1000-2000 mPa·s.

The resulting waterborne polyurethane product has a solid content of 35.0% and a hydroxyl content of 2.31% (calculated by dry solids).

### Example

The gloss was measured by using a gloss tester conforming to ISO2813, ASTMD1455, GB9754, GB8807 and other standards and measuring the gloss of the coating film at an angle of 60°.

The water resistance was measured according to GB/T1733-1993 by paint film water tolerance assay method.

Solvent resistance was measured according to GB/T23989-2009 standard by wiping with ethanol and butanone.

100 parts by weight of the waterborne polyurethanes were sampled to Example 1, Example 2 and Example 3, then 5, 10, and 15 parts by weight of water-dispersible polyisocyanate crosslinker (with NCO content of 20%) were each added into the waterborne polyurethanes as sampled, and stirred evenly to prepare two-pack coatings; the coatings were coated, cured and maintained at room temperature for 7 days to obtain a coating film, and the films were then subjected to the above measurement.

100 parts by weight of the waterborne polyurethanes were sampled to Example 1, Example 2 and Example 3, then 6, 9 and 14 parts by weight of amino resin crosslinker (such as CYMEL325) were each added into the waterborne polyurethanes as sampled, and stirred evenly to prepare one-pack coatings; the coatings were coated, and baked at 120-140° C. for 20 min to cure so as to obtain a coating film, the films were then subjected to the above measurement.

The test results are as follows:

TABLE 1
Test results of the Examples in which water-
dispersed polyisocyanate crosslinker is added

| | Example1 | Example2 | Example3 |
|---|---|---|---|
| Water resistance | Normal for 24 | Normal for 72 | Normal for 72 |
| | hours | hours | hours |
| Ethanol-tolerance | 10 times | 20 times | 50 times |
| Butanone- | 10 times | 20 times | 50 times |
| tolerance | | | |
| gloss | 0.8 | 1.2 | 1.8 |

TABLE 2
Test results of the Examples in which
amino resin crosslinker is added

| | Example1 | Example2 | Example3 |
|---|---|---|---|
| Water resistance | Normal for 72 | Normal for 72 | Normal for 72 |
| | hours | hours | hours |
| Ethanol-tolerance | 50 times | 100 times | 200 times |
| Butanone- | 50 times | 100 times | 200 times |
| tolerance | | | |
| gloss | 0.9 | 1.5 | 2.0 |

1. A hydroxyl-functional inherent matting waterborne polyurethane, comprising the following components:
15-25 parts by weight of a polymer polyol;
5-15 parts by weight of an isocyanate monomer;
0.2-0.8 parts by weight of 2,2-dimethylol propionic acid or 2,2-dimethylol butyric acid;
0.1-0.7 parts by weight of a pH regulator;
0.5-3.0 parts by weight of a hydroxyalkyl ethylenediamine chain extender;
0.1-4.0 parts by weight of a dialkyl alcohol amine blocking agent;
0.2-1.5 parts by weight of a diaminosulphonate chain extender;
0.01-0.05 parts by weight of a catalyst;
2-10 parts by weight of an organic solvent;
50-80 parts by weight of deionized water;
0.1-3 parts by weight of a thickener;
wherein, the polyurethane has a hydroxyl content of 0.5-2.5%, based on dry solids;
the method for preparing the waterborne polyurethane includes the following steps:
(a) adding the polymer polyol, isocyanate monomer, 2,2-dimethylol propionic acid or 2,2-dimethylol butyric acid, catalyst, and organic solvent to a reactor according to the above formula amount and reacting at 50-90° C. until the NCO content reaches or is less than the theoretical value, in which the isocyanate monomer is excessive;
(b) cooling the above polymer to 20-40° C., adding the formula amount of the pH regulator such as triethylamine or N-methylmorpholine, and then dispersing the above reactants into the formula amount of deionized water at a high speed;
(c) adding the formula amount of the hydroxyalkyl ethylenediamine chain extender, and reacting at 10-50° C. for 5-8 min;
(d) adding the formula amount of the diaminosulphonate chain extender, and reacting at 10-50° C. for 5-8 min;
(e) adding the formula amount of the dialkyl alcohol amine blocking agent, and reacting at 10-50° C. for another 30-60 min, to obtain a waterborne polyurethane;
(f) thickening the waterborne polyurethane with a thickener, with the proviso that before the thickening, if the organic solvent added in step (a) has a high boiling point such as N-methyl-pyrrolidone, the solvent does not require to be separated; if the solvent added in step (a) is acetone or butanone, the solvent needs to be separated under reduced pressure.

2. The waterborne polyurethane according to claim 1, wherein the polymer polyol is one of conventional polyester polyol, polytetrahydrofuran ether polyol (PTMG), ethylene oxide polyether polyol (PEG), propylene oxide polyether polyol (PPG), polycaprolactone polyol (PCL), polycarbonate polyol (PCD) and polyacrylate polyol (PA), or a mixture of several kinds thereof; the molecular weight thereof ranges from 500 to 3000, and functionality thereof ranges from 2 to 3.

3. The waterborne polyurethane according to claim 1, wherein the isocyanate monomer is one of isophorone diisocyanate (IPDI), dicyclohexylmethane diisocyanate (H MDI), tetramethylxylylene diisocyanate (TMXDI), xylylene diisocyanate (XDI), and 2,4- and/or 2,6-toluene diisocyanate (TDI), or a mixture of several kinds thereof.

4. The waterborne polyurethane according to claim 1, wherein the hydroxyalkyl ethylenediamine chain extender is one of hydroxyethyl ethylenediamine, N,N-dihydroxyethyl ethylenediamine, hydroxypropyl ethylenediamine, and (1,2-ethanediyldiimino)bis-1-butanol, or a mixture of several kinds thereof.

5. The waterborne polyurethane according to claim 1, wherein the dialkyl alcohol amine blocking agent is one of diethanolamine, diisopropanolamine and dibutanolamine, or a mixture of several kinds thereof.

6. The waterborne polyurethane according to claim 1, wherein the diaminosulphonate chain extender is one of sodium 2-[(2-aminoethyl)amino]ethanesulfonate and/or sodium 3-[(2-aminoethyl)amino]propanesulfonate.

7. The waterborne polyurethane of claim 1, wherein the organic solvent is one of N-methylpyrrolidone, N-ethylpyrrolidone, dimethylacetamide, dimethylformamide, acetone and ketone, or a mixture of several kinds thereof.

8. The waterborne polyurethane according to claim 1, wherein the thickener is one of alkali-swelling polyacrylic acid and associative hydrophobically modified polyurethane, or a mixture of several kinds thereof.

9. A method for preparing a two-pack or one-pack inherent matting waterborne coatings by using the hydroxyl-functional inherent matting waterborne polyurethane according to claim 1, comprising the following steps:
adding 5-20% by weight of a water-dispersed polyisocyanate crosslinker into the hydroxyl-functional inherent matting waterborne polyurethane, to obtain a two-pack coating, which may be cured at room temperature;
adding 5-18% by weight of an amino resin crosslinker into the hydroxyl-functional inherent matting waterborne polyurethane, to obtain a one-pack coating, which may be cured after being baked at 120-140° C. for 20 min;
wherein paintcoats prepared by above coatings exhibit low gloss, and excellent water-resistance and solvent resistance, and have a gloss of less than 1.0 at an angle of 60 degrees; they can be widely used in various substrates such as leather, fabric, wood, metal, cement, and plastic.
